(19) United States
(12) Patent Application Publication
(10) Pub. No.: US 2024/0321133 A1
(43) Pub. Date: Sep. 26, 2024

(54) AUTO-GENERATED READING PASSAGES USING GENERATIVE ARTIFICIAL INTELLIGENCE

(71) Applicant: Microsoft Technology Licensing, LLC, Redmond, WA (US)

(72) Inventors: Michael THOLFSEN, Newcastle, WA (US); Ella BEN TOV, Tel Aviv (IL); Shay BEN-ELAZAR, Herzliya (IL); Paul Ronald RAY, Kirkland, WA (US); Yonatan TURKIN, Givatayim (IL); Tyler Jonathan CITRIN, Springfield, NJ (US); Letitia KWAN, Seattle, WA (US); Priya CHAUHAN, Duvall, WA (US); Yossef Hai BEN DAVID, Tel Aviv (IL); Hagar GELBARD, Herzliya (IL); Merav MOFAZ, Herzliya (IL); Shira SIDON COHEN, Herzliya (IL); Carlos Alexis GONZALEZ GOMEZ, Redmond, WA (US); Murtuza Sarfraz SHAKIR, Sammamish, WA (US); Eun Ju NAM, Sammamish, WA (US)

(21) Appl. No.: 18/336,407

(22) Filed: Jun. 16, 2023

Related U.S. Application Data
(60) Provisional application No. 63/491,508, filed on Mar. 21, 2023.

(51) Int. Cl. G09B 17/00; G09B 5/02

(52) U.S. Cl. CPC G09B 17/003; G09B 5/02

(57) ABSTRACT

Technology is disclosed herein for a software application which identifies trouble words related to reading ability and generates a prompt for a custom reading passage based on the trouble words. The application submits the prompt to a foundation model service and receives the custom reading passage generated based on the prompt. In an implementation, the application receives parameters relating to characteristics of the custom reading passage via a user interface of the application. The parameters may include topic, age range, length, reading difficulty, and language. In some implementations, identifying the trouble words includes displaying a set of trouble words generated by a speech engine in the user interface and receiving user input including a selection of the trouble words from the set. In some implementations, the application executes in a context of a collaboration application on the user computer.

### RELATED APPLICATIONS

This application is related to and claims the benefit of priority to U.S. Provisional Patent Application No. 63/491,508, entitled AUTO-GENERATED READING PASSAGES USING GENERATIVE ARTIFICIAL INTELLIGENCE, and filed on Mar. 21, 2023, the contents of which are hereby incorporated by reference in their entirety.

### TECHNICAL FIELD

Aspects of the disclosure are related to the field of computer software applications and, in particular, to technology solutions for reading instruction.

### BACKGROUND

Classroom instruction, including reading instruction, is increasingly moving online. Many software tools exist for creating groups, assigning tasks, and otherwise managing a classroom online, but reading instruction remains the same as in the offline world. For example, a teacher may connect with a student on a video conference call and have the student read selected text aloud. Just as in the physical classroom, the teacher listens to the student read and provides feedback over the call.

In any class, there are as many reading abilities as there are students. The teacher faces the challenge of addressing the many variations in ability in a class while shepherding the students toward competency. Students may exhibit competency in some language areas but need additional practice in other areas according to their individual abilities. Students who become proficient readers will need the challenge of more sophisticated language materials to continue building proficiency. However, reading and language instruction tools are often designed based on a general expectation or understanding about students' ability according to age or grade level which provides, at best, a relatively rough estimation of ability for, in many classes, a highly diverse range of reading ability.

### OVERVIEW

Technology is disclosed herein for a software application which identifies trouble words related to reading ability and generates a prompt for a custom reading passage based on the trouble words. The application submits the prompt to a foundation model service and receives the custom reading passage generated by the foundation model service based on the prompt.

In an implementation, the application receives parameters relating to characteristics of the custom reading passage via a user interface of the application. In some implementations, the prompt is based on the parameters. The parameters may relate to characteristics of the custom reading passage including topic, age range, length, reading difficulty, and language.

In some implementations, identifying the trouble words includes displaying a set of trouble words generated by a speech engine in the user interface and receiving user input including a selection of the trouble words from the set. In some implementations, the application executes in a context of a collaboration application on the user computer.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational example of a foundation model integration with a reading application in an implementation.

FIG. 2 illustrates a method of operating a reading application with a foundation model integration in an implementation.

FIG. 3 illustrates a systems architecture for a foundation model integration with a reading application in an implementation.

FIG. 4 illustrates an operational scenario of operating a reading application with a foundation model integration in an implementation.

FIGS. 5A-5F illustrate user experiences of an operational scenario of a foundation model integration with a reading instruction application in an implementation.

FIG. 6 illustrates a user experience of a foundation model integration with a reading instruction application in an implementation.

FIGS. 7A-7C illustrate user experiences of an operational scenario of a foundation model integration with a reading instruction application in an implementation.

FIGS. 8A-8F illustrate user experiences of an operational scenario of a foundation model integration with a reading instruction application in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for the integration of application service for reading instruction with a foundation model service. In an implementation, an application service directed toward reading instruction receives customized reading passages from the foundation model service. The reading passages are customized to target words identified as troublesome for students learning to read. The application service displays a user interface in which a user, such as a teacher, can request and receive a custom reading passage configured according to characteristics of the target audience or student readers, then generate a reading assignment based on the custom reading passage. Custom reading passages include reading passages which are generated on-demand and which are tailored according to parameters relating to reading ability.

The application service is directed to automatically generating highly targeted reading passages, such as for students in a class, using generative artificial intelligence (AI). The passages may be generated to allow practicing of words that student(s) have been known to have trouble with, to practice certain phonics rules, etc.

In the education context, the existing Reading Progress module of the application service may be used in combination with the Open AI application programming interface (API) and an EDU API layer. Known trouble words can be obtained from the Reading Progress module using the Microsoft Insights platform. The trouble words are submitted to an EDU API that sits on top of the OpenAI API to generate targeted reading passages that incorporate the trouble words with some frequency. The passage initiator (e.g., teacher or instructor) may also select a category of the reading passage, a passage length, age range, language, and other factors.

For example, an application executing on a user computing device presents a user interface in which a user, such as a teacher, reading coach, or reading instructor, can configure a reading assignment based on a custom reading passage. In the user interface, the application displays trouble words, i.e., words which are determined to be troublesome as related to a student's reading ability. The trouble words are identified, in some scenarios, by a speech engine, such as Microsoft Insights, based on speech data for students learning to read. The user interface of the application receives user input which indicates a selection of the trouble words. The user interface may also receive user input relating to characteristics to further individualize the custom reading passage such as topic, genre, age level of the reader, passage length, difficulty, language, and so on. In some implementations, the application may identify a location of the user based on, for example, an IP address, and configure a default language based on the detected location. In some implementations, the application service may task the foundation model service with including words that are similar to the trouble words or words that include troublesome phonemes or illustrate troublesome phonetic rules in the bespoke reading passage.

The application service generates a prompt which elicits a response from a foundation model of a foundation model service, such as a large language model (LLM) of an LLM service, for a custom reading passage that includes the trouble words selected by the user and configured according to characteristics selected by the user according to characteristics of the student reader. The prompt may include rules or instructions to task the foundation model in responding to the prompt, such as evaluating the passage for inappropriate content and language. The prompt may instruct the foundation model in some scenarios to generate factual content and to evaluate the content for accuracy. The prompt may also direct the foundation model to localize the passage by incorporating cultural phenomenon (e.g., names, places, landmarks, foods, modes of transportation, animals, weather, geography, historical figures) based on a detected location of the computing device or for a location specified by the user. For example, a prompt received from a computing device in France will direct the foundation model to localize the passage to what would be familiar to French students or typical of or common to a student's life in France.

Upon submitting the prompt to the foundation model, the application service receives output from the foundation model including the requested passage. The application service may perform a content moderation operation on the output from the foundation model. For example, the application service may evaluate the output to ascertain the grade level or level of difficulty and provide a follow-up prompt to the foundation model to modify the output (e.g., make the passage more or less difficult) if the ascertained grade level or level of difficulty is not appropriate.

The application service displays the passage in the user interface and presents the user with options for configuring a reading assignment based on the passage. In some implementations, the trouble words selected by the user are highlighted in the prompt for the user's convenience. The user interface may also present an option for modifying the user input and generating a new passage, such as changing the length of the passage or the level of difficulty. In some scenarios, the user can export the passage generated by the foundation model in a file such as a Word document or PDF, or copy/paste the passage into another application, such as an email message, for other handling.

In some implementations, the speech data may also include phonics identified by the speech engine as troublesome for students learning to read. For example, the user may be presented with phonics or letter combinations detected by the speech engine as ones with which the target audience is prone to making reading errors. The user may request a custom reading passage including words which incorporate difficult or troublesome phonics, letter combinations, or phonemes identified by the speech engine.

In still other implementations, the application service may present trouble words or phonics based on a generalized dataset of trouble words or phonics broadly correlated to age or grade level. For example, a teacher may configure a reading assignment to survey a class of readers, then configure and generate individualized reading assignments based on the results. In some implementations, the reading instruction application recommends parameters for generating a custom reading passage.

To configure an assignment based on the custom reading passage, the application service presents a number of options to configure how student readers can complete the assignment, such as implementing a time limit or number of attempts. In particular, the user may select to incorporate the use of the speech engine as part of the assignment. The speech engine captures and analyzes audio input of a student reader reading the passage, providing the user with feedback specific to a particular student's reading ability relating to the trouble words or phonics.

In other implementations of the disclosed technology, the application service presents to a student a student-initiated immersive reading context in the user interface. In the immersive reading context, the student initiates the generation of custom reading passages according to selections or user input provided by the student. The student may elect to create a short story which incorporates the student's trouble words, that is, words identified by the application as ones on which the student should have additional practice. Alternatively, the student may elect to create an ongoing story guided by the student's input and incorporating the students' trouble words. As the student-initiated stories or passages are presented in the user interface, the student may use a reading coach functionality or speech engine to record the student reading the stories or passages aloud and to provide feedback to the student and to the student's reading instructor) with respect to the student's reading with respect to the trouble words or other words in the generated content. In some implementations, the application service sends aspects of the student's input to an AI artwork generator and receives custom artwork to display in the user interface with the student-initiated stories.

Foundation models of implementations of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Foundation models may be multimodal or unimodal depending on the modality or modalities of the inputs (discussed infra). Types of foundation models may be broadly classified as or include pre-trained models, base models, and knowledge models, depending on the particular characteristics or usage of the model.

Multimodal models are a class of foundation model which leverages the pre-trained knowledge and representation abilities of foundation models to extend their capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image, for example, by using an image encoder to extract visual features, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video-generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Visual multimodal or foundation models also include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a unimodal type of foundation model which processes and generates natural language text. These models are trained on massive amounts of text data and learn to generate coherent and contextually relevant responses given a prompt or input text. LLMs are capable of sophisticated language understanding and generation capabilities due to their trained capacity to capture intricate patterns, semantics and contextual dependencies in textual data. In some scenarios, LLMs can incorporate additional modalities, such as combining images or audio with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are novel, open-ended, and unpredictable.

In some implementations, the technology disclosed herein incorporates a foundation model service, such as a multimodal model service hosting a multimodal model, to teach a variety of subjects beyond reading instruction, such as subjects in the social sciences (e.g., history, geography), scientific subjects (e.g., biology, chemistry, astronomy), math subjects (e.g., geometry, statistics, game theory), or subjects in the visual arts, (e.g., fine art appreciation, photography, art history). In an implementation, prompts including selected text and/or imagery can be fed into a multimodal learning instruction environment to generate customized text or images for instructional activities such as identifying a protein conformation, graphing or charting data for analysis, map reading, geometric proofs, and so on.

The application of the application service for reading instruction may be a stand-alone application or integrated in the context of another application, operating system, or computing environment. For example, the application may be implemented as an application natively installed and executing on a user computer or a browser-based application running in the context of a web browser. In some implementations, the application may execute within the context of a collaboration or conferencing application, such as Microsoft Teams®.

Technical effects may be appreciated from the technology disclosed herein include a streamlined process and interface by which reading assignments can be individually tailored according to the reader's ability by integrating automated reading analysis tools (e.g., speech engines) to create customized reading passages on demand. A number of technical advantages accrue based on the integrated process of creating assignments tailored to the specific concerns or issues of a particular student reader, group of student readers, or class. A teacher can create an assignment targeting specific words or phonics based on analysis and feedback of the students' reading ability to provide those students with additional practice. Customizing the requested passage according to age, reading ability, or level of difficulty allows the teacher to use techniques such as scaffolded learning to gradually introduce new or more difficult vocabulary to students. In addition, to encourage engagement, the application presents the user with the ability to configure assignments according to a topic or genre. For example, the teacher may generate reading assignments not only according to reading ability but also which overlap with other subjects that the students are studying at that time, such as science, geography, or history. Reader engagement is also promoted by allowing students to generate reading passages based on interest in a controlled manner which supervises the generated content to ensure the student is presented with safe and appropriate content according to the student's reading ability.

Other technical advantages may be appreciated from the disclosed technology. Prompts tailored according to the disclosed technology reduce the amount of data traffic between the application service and the foundation model service for generating useful content for a reader. For example, the disclosed technology streamlines the interaction between the user (e.g., a teacher) and the application service by generating prompts which keep the LLM on task and reduce the incidence of erroneous, inappropriate, or off-target replies. The disclosed technology also promotes more rapid convergence, that is, reducing the number of interactions with the LLM to generate a desired result.

In addition, the disclosed technology focuses the generative activity of the foundation model to improve the performance of the foundation model without overwhelming the foundation model (e.g., by exceeding a token limit). For example, the disclosed technology balances prompt size (e.g., the number of tokens in the prompt which must be processed by the foundation model) with providing sufficient information to generate a useful response. Other technical benefits accruing from streamlined interaction, more rapid convergence, and optimized prompt sizing include reduced data traffic, faster performance by the foundation model, reduced latency, and concomitant improvements to productivity costs and to the end-user experience.

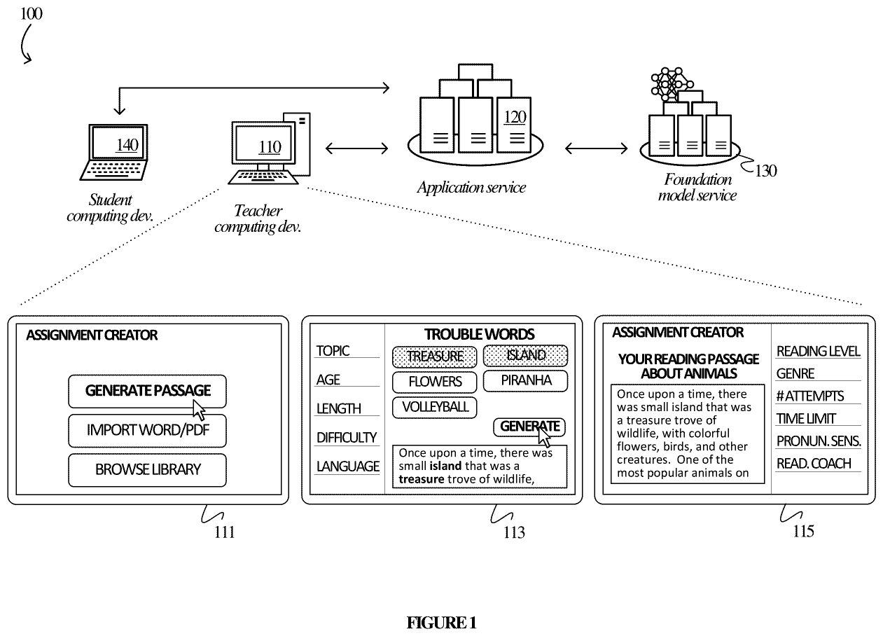

FIG. 1 illustrates operational environment 100 for an application service with an LLM integration for generating customized or personalized reading passages in an implementation. Operational environment 100 includes application service 120 which communicates with teacher computing device 110, student computing device 140, and foundation model service 130. Application service 120 hosts a reading instruction application for endpoints such as teacher computing device 110 and student computing device 140 which execute applications that provide a local user experience and which interface with application service 120. The reading instruction application of application service 120 may be implemented in a natively installed and executed application, and may execute in a stand-alone manner, within the context of another application such as a collaboration or conferencing application, or in some other manner entirely. Foundation model service 130 hosts a generative pretrained transformer (GPT) computing architecture such as GPT-3®, GPT-3.5, ChatGPT®, or GPT-4.

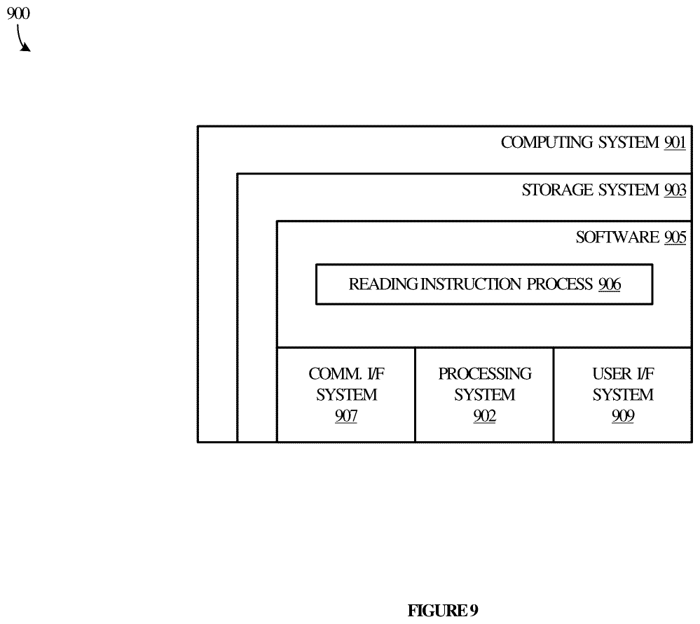

Teacher computing device 110 and student computing device 140 are representative of computing devices, such as laptops or desktop computers, mobile computing devices, such as tablet computers or cellular phones, and any other suitable devices of which computing device 901 in FIG. 9 is broadly representative. Teacher computing device 110 and student computing device 140 communicate with application service 120 via one or more internets and intranets, the Internet, wired or wireless networks, local area networks (LANs), wide area networks (WANs), and any other type of network or combination thereof. A user interacting with teacher computing device 110 interacts with the reading instruction application of application service 120 via a user interface of the application displayed on teacher computing device 110. User experiences 111, 113, and 115 are representative of user experiences of an assignment creation environment of a reading instruction application hosted by application service 120 in an implementation.

Application service 120 is representative of one or more computing services capable of hosting a reading instruction application and interfacing with teacher computing device 110 and student computing device 140. Application service 120 may be implemented in software in the context of one or more server computers co-located or distributed across one or more data centers. Examples of services or sub-services of application service 120 include—but are not limited to—voice and video conferencing services, collaboration services, file storage services, and other application services. In some examples, application service 120 may provide a suite of applications and services with respect to a variety of computing workloads such as office productivity tasks, email, chat, voice and video, and so on.

Application service 120 employs one or more server computers co-located or distributed across one or more data centers connected to student computing device 140 and teacher computing device 110. Examples of such servers include web servers, application servers, virtual or physical servers, or any combination or variation thereof, of which computing device 901 in FIG. 9 is broadly representative. Application service 120 may communicate with student computing device 140 and teacher computing device 110 via one or more internets, intranets, the Internet, wired and wireless networks, LANs, WANs, and any other type of network or combination thereof.

Foundation model service 130 is representative of one or more computing services capable of hosting a foundation model computing architecture and communicating with application service 120. Foundation model service 130 may be implemented in the context of one or more server computers co-located or distributed across one or more data centers. Foundation model service 130 hosts a deep learning AI model, such as ChatGPT®, BERT, ERNIE, T5, XLNet, or other multimodal or unimodal model, which is integrated with the spreadsheet environment associated with application service 120.

In operation, teacher computing device 110 hosting a reading instruction application receives a set of trouble words from application service 120. A user (e.g., a teacher) selects to generate a custom reading passage for a reading assignment as illustrated in user experience 111. As illustrated in user experience 113, the reading application displays trouble words along with parameters for generating a custom reading passage for the assignment. In an implementation, the set of trouble words are words which have been empirically determined by a speech engine of application service 120 to be difficult, challenging, or troublesome to read for one or more students. In user experience 113, the user selects trouble words presented in user experience 113 along with parameters to further customize the reading passage according to characteristics of the target audience (e.g., student readers). Upon clicking the graphical button “Generate,” the reading instruction application of teacher computing device 110 submits a request to application service 120 for a custom reading passage based on the selected trouble words and parameters.

Application service 120 generates a prompt for foundation model service 130 based on the trouble words and parameters received from teacher computing device 110. In an implementation, application service 120 generates a prompt which tasks foundation model service 130 with generating a reading passage which incorporates the trouble words and which is composed for student readers according to the submitted parameters. For example, the prompt may specify the custom reading passage be of moderate difficulty for 11-year-old students or for fifth grade students, 200-300 words in length, be fictional, be localized to the state of Washington, and contain no inappropriate content. Application service 120 submits the prompt to foundation model service 130, for example, via an application programming interface supported by foundation model service 130.

Upon receiving the prompt, foundation model service 130 generates a custom reading passage incorporating the trouble words and according to the parameters in the prompt and submits the custom reading passage to application service 120. Application service 120 receives the custom reading passage and examines the passage based on criteria such as appropriateness of the content (e.g., that the passage contains no offensive content), the level of difficulty, the frequency of use of the trouble words, and so on.

When application service 120 determines the passage satisfies the request from teacher computing device 110, application service 120 sends the custom reading passage to the reading instruction application of teacher computing device 110 for display, as illustrated in user experience 115. In user experience 115, the user can configure the assignment in the assignment creation environment based on the custom reading passage, including selecting due dates, time limits, number of attempts, student readers to be given the assignment, and so on. The user may request a new passage be generated based on the original trouble words and parameters or according to different selections by the user. The user may also select to use the speech engine of application service 120 with the assignment to provide feedback on students' completion of the assignment. In selecting the speech engine, the user may further select the level of sensitivity to pronunciation which throttles the detection and response of the speech engine with regard to students' vocal reading abilities.

In some implementations, if application service 120 determines that the custom reading passage received from foundation model service 130 is not satisfactory with respect to the request, application service 120 may generate a follow-on prompt which tasks foundation model service 130 with generating a new custom passage according to modified instructions modified in response to the custom reading passage and its evaluation with respect to the request.

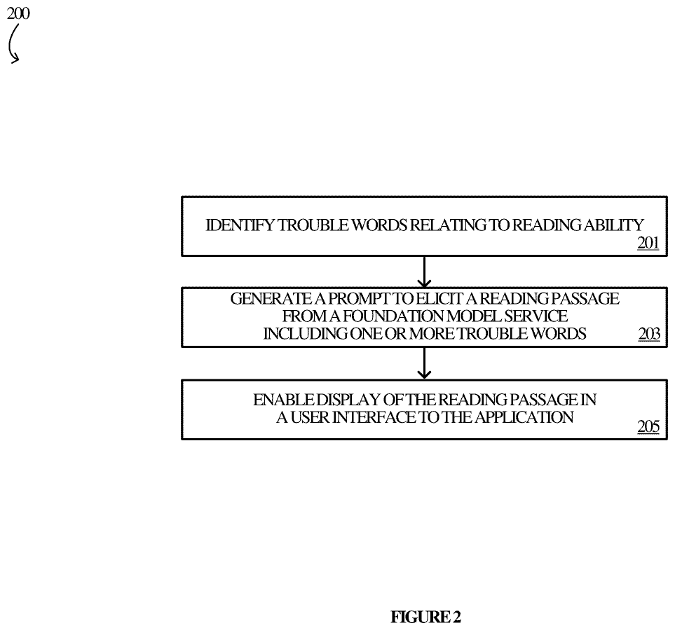

FIG. 2 illustrates a method of operating an application service for reading instruction with a foundation model integration in an implementation, hereinafter referred to as process 200. Process 200 may be implemented in program instructions in the context of any of the software applications, modules, components, or other such elements of one or more computing devices. The program instructions direct the computing device(s) to operate as follows, referred to in the singular for clarity.

An application service hosts a web-based reading instruction application or module and displays a user interface for a client application of the application service on a user computing device remote from the application service. In an implementation of the client application, a user, such as a teacher, can create a reading assignment customized for a target audience, such as one or more student readers, in an assignment creation environment. The application service also interfaces with a foundation model service, such as an LLM service, based on inputs received from the user via the user interface.

In an implementation, the application service identifies trouble words relating to one or more students' reading ability (step 201). In an implementation, to identify trouble words, the application service uses a speech engine which captures audio of a student reader and detects words with which the reader is having difficulty in reading or pronouncing. The speech engine generates a list of recommended words or phonics which it determines would be beneficial for the reader(s) to practice. The application service presents in the user interface of the client application the words or phonics from which the teacher can select one or more of the words when creating a reading assignment. The teacher may also input in the user interface of the reading instruction application other assignment-related parameters according to the reading ability of the targeted reader(s), the goals of the assignment, or other educational considerations.

The application service receives the selected trouble words or phonics from the client application for the requested custom reading passage and generates a prompt for the foundation model service based on the selected trouble words or phonics (step 203). The prompt includes the selected trouble words or phonics and tasks the foundation model service with creating a reading passage customized according to the parameters supplied in the request. In an implementation, the prompt may task the foundation model with constraining its output to content which is appropriate for the target audience according to age and reading level, and to localize the content according to a location detected by the application service of the teacher computing device or a location specified by the teacher. The prompt may instruct the foundation model service to provide a custom reading passage of a particular word length (e.g., 150 to 250 words) and to compose the reading passage according to a particular topic or genre. The prompt may task the foundation model with identifying and including words which are similar to the trouble words, for example, to increase the level of difficulty of the reading passage. The prompt may further instruction task the foundation model with generating a title for the custom reading passage.

The prompt generated by the application service based on the trouble words may also instruct the foundation model service to avoid certain types of content, such as content, language, or subject matter which may be personally or culturally insensitive or inappropriate. The prompt may also task the foundation model service with output its custom reading passage in a particular format by which the application service can parse the output to retrieve the passage or to tag the trouble words or words including the trouble phonics so the application service can highlight them in the display in the user interface. In some implementations, the application service may task the foundation model service with generating multiple custom reading passages according to varying levels of reading difficulty based on the same topic or subject matter by which the teacher can create multiple individualized versions of a reading assignment.

The application service submits the prompt to the foundation model service. In some implementations, the prompt is submitted via an API supported by the foundation model service. The application service receives output including the custom reading passage from the foundation model service based on the prompt.

Upon receiving the output, in an implementation, the application service parses the output to extract the custom reading passage and enables display of the reading the passage in the user interface of the client application (step 205). For example, in the assignment creation environment, the teacher can assess the custom reading passage received and, if desired, request a new passage based on the original inputs or a new passage based on modified inputs.

In various implementations, the assignment creation environment provides the teacher with options for configuring a reading assignment based on the custom reading passage, such as specifying a due date or time limit, a number of attempts, the use of a reading coach or speech engine for feedback on student performance of the assignment, and so on. The environment may present the teacher with adding or modifying the content of the custom reading passage, such as adding or modifying a title of the passage. In some implementations, the teacher can save the custom reading passage and add tags to the passage by which the teacher can search for the passage for other assignments. In some implementations, the teacher can also print the custom reading passage or export the passage to a Word document or PDF.

Referring back to FIG. 1, operational environment 100 includes a brief example of process 200 as employed by elements of operational environment 100, such as application service 120 and teacher computing device 110. In operation, application service 120 identifies trouble words relating to reading ability in a client application for reading instruction executing on teacher computing device 110. In an implementation, to identify trouble words, application service 120 receives trouble words as determined by a speech engine which captures audio data of a student reading a passage and analyzes the data to identify words, letters, or phonics with which the student has some difficulty reading. Application service 120 receives user input from the client application requesting a custom reading passage based on one or more of the trouble words. Application service 120 configures a prompt for submission to foundation model service 130 based on the trouble words. The prompt tasks foundation model service 130 with generating a custom reading passage based at least on the trouble words. In some implementations, the prompt includes parameters according to which foundation model service 130 generates the passage with respect to length and difficulty or with respect to characteristics of the intended reader.

Application service 120 submits the prompt based at least on the trouble words to foundation model service 130 and receives a custom reading passage from foundation model service 130 based on the prompt. Application service 120 configures the reading passage for display in the user interface of the client application and presents the user in the user interface with options for incorporating the reading passage into a reading assignment.

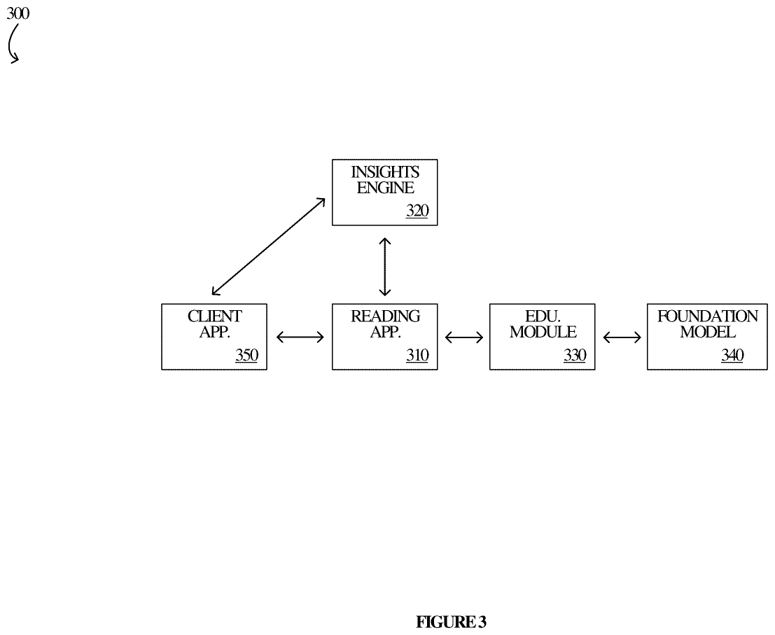

FIG. 3 illustrates systems architecture 300 in an implementation of a foundation model integration with a reading instruction service, such as application service 120 of FIG. 1. Systems architecture 300 includes client application 350, reading application 310, insights engine 320, education module 330, and foundation model 340.

Reading application 310 provides one or more services relating to reading instruction and is representative of any application capable of running on a computing device, such as a desktop or laptop computer or mobile device, and interfacing with an online service such as insights engine 320 and education module 330. Reading application 310 may be a stand-alone application or may be integrated in the context of another application, an operating system, or other such environment. Reading application 310 may also be a natively installed and executed application, a browser-based application that runs in the context of a web browser, a streaming (or streamed) application, a mobile application, or any other type of application.

Insights engine 320 provides one or more services relating to reading instruction to endpoints such as client application 350 and reading application 310. Examples of such services include—but are not limited to—capturing or receiving audio data relating to reading instruction, such as recorded audio of a student reading aloud a selected passage, and analyzing the audio data to generate insights into words, sounds, phonemes, or phonetic rules which the student is having some measure of difficulty in reading. In an implementation, insights engine 320 is a specific-purpose AI module which executes independently of foundation model 340. Insights engine 320 may execute on one or more server computers co-located or distributed across one or more data centers connected to computing devices on which client application 350 or reading application 310 operate. While contemplated as a sub-service of reading application 310 or client application 350, insights engine 320 may also be implemented as a separate service independent from reading application 310 or client application 350. In an implementation, reading application 310 may interface with insights engine 320 via an API.

Education module 330 of systems architecture 300 provides one or more services relating to reading instruction. Examples of such services include—but are not limited to—generating prompts for generating custom reading passages by foundation model 340 and receiving and configuring output from foundation model 340 for display in reading application 310 and/or client application 350. For example, education module 330 may create a prompt tasking foundation model 340 with generating a custom reading passage based on words (e.g., trouble words) identified by insights engine 320. Education module 330 may execute on one or more server computers co-located or distributed across one or more data centers connected to computing devices on which client application 350 or reading application 310 operate. While contemplated as a sub-service of reading application 310 or client application 350, education module 330 may also be implemented as a separate service independent from reading application 310 or client application 350. Similarly, insights engine 320 and education module 330 may each be implemented independent of each other. In an implementation, reading application 310 may interface with education module 330 via an API.

Foundation model 340 is representative of one or more computing services capable of hosting a foundation model computing architecture and communicating with education module 330 and/or reading application 310. Foundation model service 340 may be implemented in the context of one or more server computers co-located or distributed across one or more data centers. Foundation model 340 hosts a deep learning AI model, such as ChatGPT®, BERT, ERNIE, T5, XLNet, and the like, which is integrated with a reading instruction environment associated with reading application 310 and/or client application 350.

Client application 350 provides one or more services relating to reading instruction and is representative of any application capable of running on a computing device, such as a desktop or laptop computer or mobile device, and interfacing with an online service such as reading application 310 and insights engine 320. Client application 350 may be a stand-alone application or may be integrated in the context of another application, an operating system, or other such environment. Client application 350 may also be a natively installed and executed application, a browser-based application that runs in the context of a web browser, a streaming (or streamed) application, a mobile application, or any other type of application.

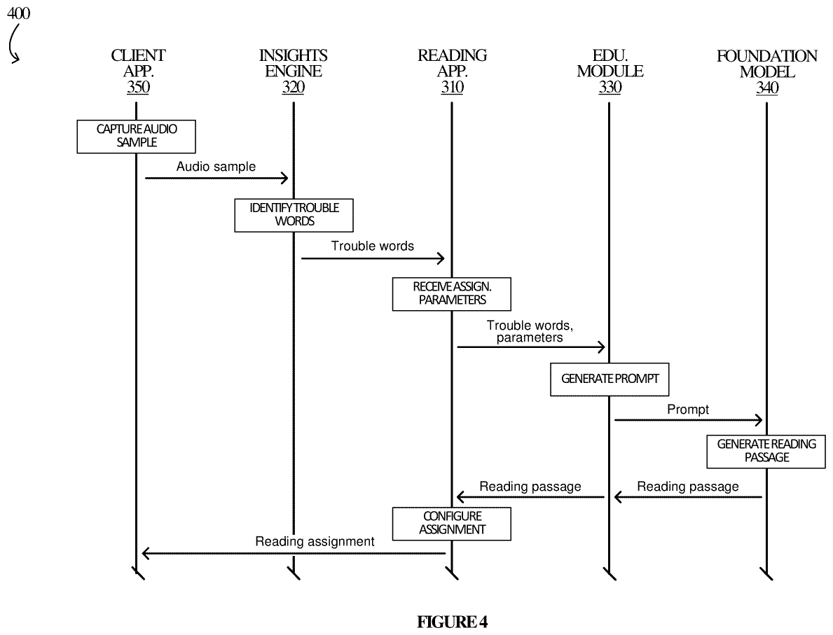

FIG. 4 illustrates operational scenario 400 with respect to the elements of FIG. 3 in an implementation. In operation, client application 350 executes an audio capture functionality to capture an audio recording of a student reading a selected passage. Client application 350 sends the audio sample data to insights engine 320 for analysis. Insights engine 320 determines from the audio data a set of words, phonemes, or phonetic rules which the student has demonstrated some measure of difficulty, challenge, or trouble in reading, such as in pronunciation or prosody. Insights engine 320 provides the data set to reading application 310.

Reading application 310 receives the set of trouble words and configures the user interface to display the troublesome words, phonemes, or phonetic rules to the teacher or reading instructor. In the user interface, the teacher elects to create a reading assignment including a custom reading passage incorporating one or more of the trouble words or words including the trouble phonemes or phonetic rules detected by insights engine 320. The user interface of reading application 310 also receives selections indicative of parameters for configuring a custom reading passage for the reading assignment, such as a topic for the passage, length, level of difficulty, student's age or age range, and so on. Upon receiving the selections of trouble words, phonemes, or phonetic rules, reading application 310 submits the selections to education module 330.

Education module 330 receives the teacher-provided input, including selected trouble words, phonemes, and/or phonetic rules and parameters, from reading application 310 and generates a prompt for foundation model 340 which tasks foundation model 340 with generating a custom reading passage based on the teacher-provided input. Education module 330 submits the prompt to foundation model 340 which generates a custom reading passage in accordance with the rules or instructions in the prompt. Foundation model 340 returns output to education module 330 including the custom reading passage. Education module 330 receives the output and extracts the custom reading passage from it. In some implementations, education module 330 executes a content moderation layer which evaluates the custom reading passage for appropriate content and difficulty as well as responsive to the other parameters selected by the teacher. Upon finding the custom reading passage to be satisfactory, education module 330 sends the custom reading passage to reading application 310 for display in the user interface.

In the user interface of reading application 310, the teacher is presented with the custom reading passage along with a set of configuration options for creating a reading assignment based on the custom reading passage. When the teacher has configured the reading assignment and submitted it for distribution, reading application 310 propagates the assignment to client application 350 for the student to complete.

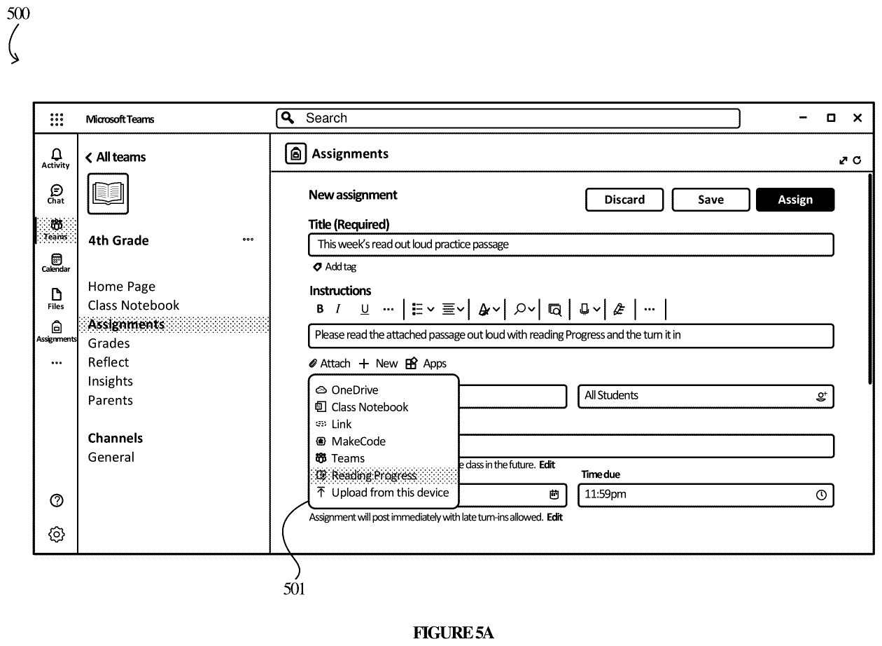

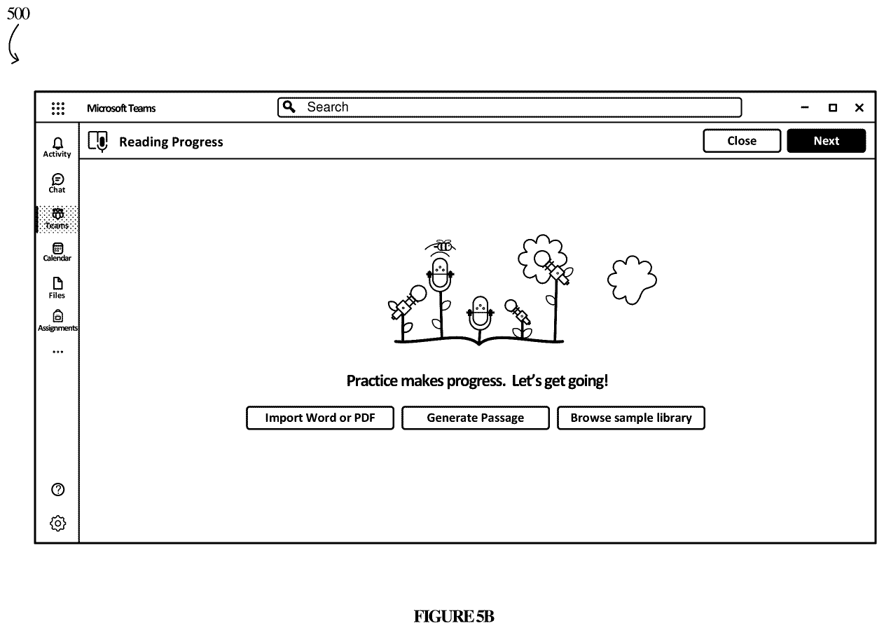

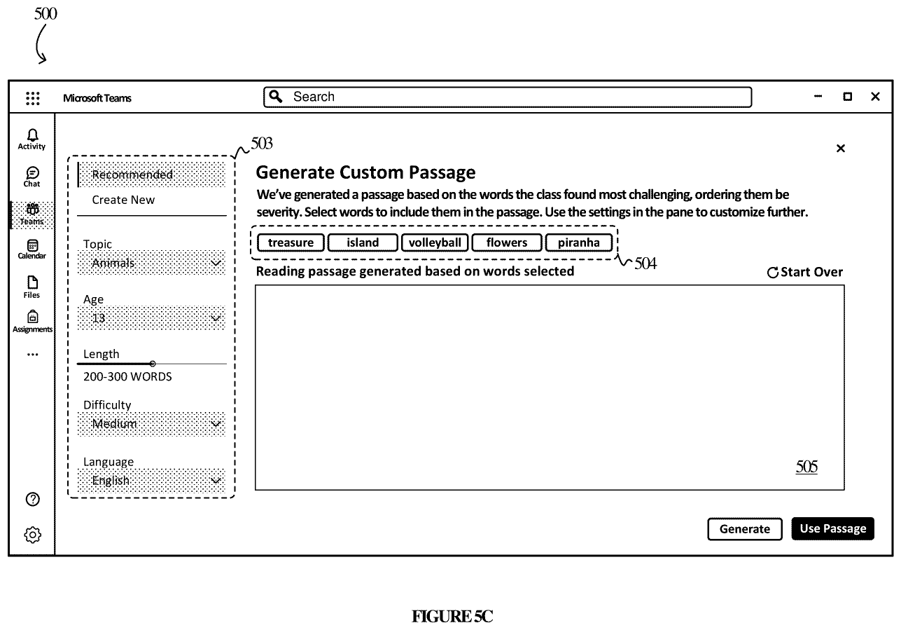

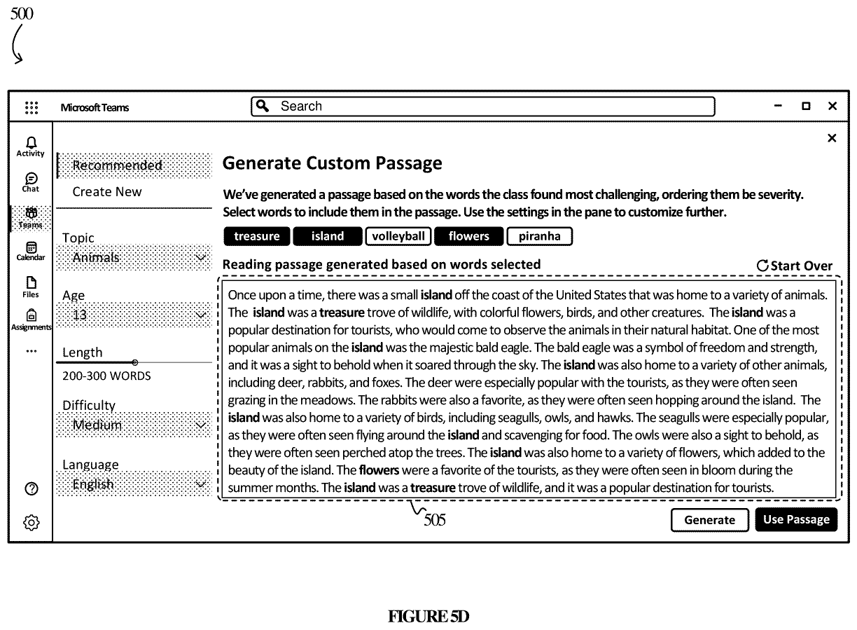

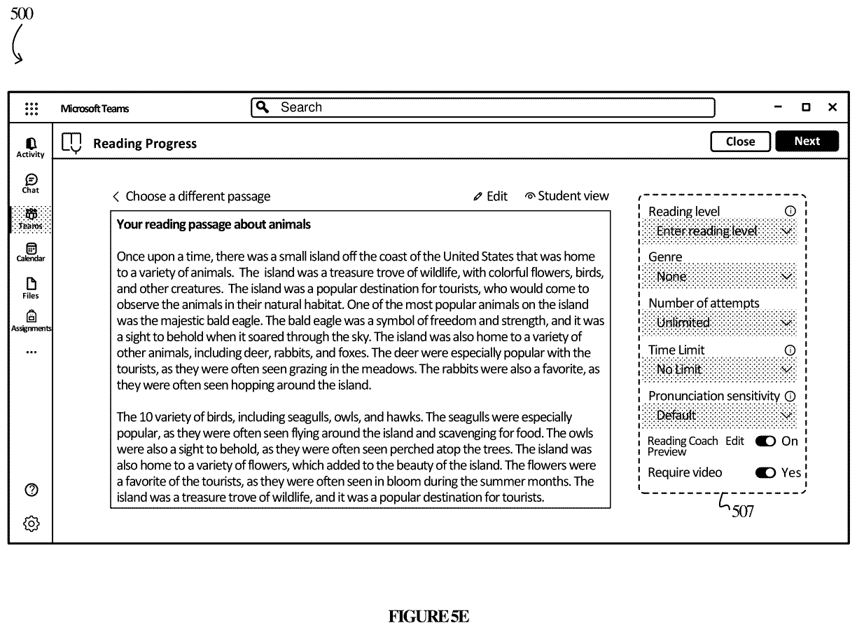

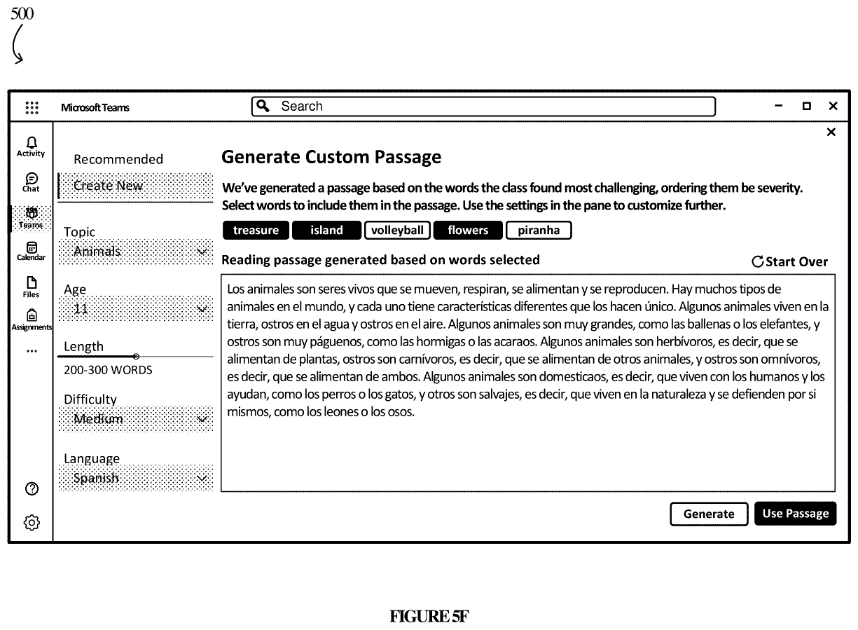

FIGS. 5A-5F illustrate exemplary user experience 500 in an implementation that is representative of the user experiences discussed above. In a brief example of the technology disclosed herein, user experience 500 illustrates a user interface generated and displayed by a reading instruction application on a computing device. As illustrated in FIG. 5A, the reading instruction application may execute within the context of a collaborative application, examples of which include Microsoft® Teams. The user interface displays an assignment creation environment and includes drop-down menu 501 by which a teacher can select to create a Reading Progress assignment.

FIG. 5B continues user experience 500 illustrates a user interface generated and displayed by the application when the user selects the Reading Progress assignment type in drop-down menu 501. As illustrated in FIG. 5B, the teacher or other user can import a Word document or PDF file containing reading text, generate a custom reading passage based on select words and/or reading parameters, or browse a sample library of reading texts.

In FIG. 5C, user experience 500 illustrates a user interface generated and displayed by the application when the user selects the “Generate Passage” graphical button shown in FIG. 5B. In user experience 500, the teacher is presented with trouble words 504, that is, words identified by a speech engine of the application, such as Microsoft Insights operating in conjunction with Microsoft Teams, as being the most challenging for a class and presented in the order of severity as determined by the speech engine. The teacher can select from among the presented trouble words and configure parameters for generating a custom reading passage.

In configuration pane 503 of FIG. 5C, the teacher can include parameters which specify characteristics of the reading passage, for example, based on the characteristics of the target audience or reader(s). In configuration pane 503, the teacher can select to create new customized reading passage based on the specified parameters or to receive a reading passage recommended by the application based on, for example, reading ability data captured by the speech engine. Upon selecting to receive a customized reading passage, the teacher can select a topic, such as Animals, Sports, Plants, Travel, Occupations, a user-specified topic, etc. The teacher can also specify the age, age range, or grade level of the custom reading passage by which the foundation model can choose, for example, appropriate subject matter and level of sophistication in the vocabulary. The teacher can specify a passage length, such as a number of words or time to read, and level of difficulty. The teacher can also specify the language, such as English, Spanish, French, and so on. Other options for configuring the custom reading passage may be presented as well, such as including a second topic, localizing the custom reading passage to a particular state or country, a genre (such as fictional, non-fiction, historical, adventure, etc.) or entering words selected by the teacher to include in the passage. Upon clicking the “Generate” graphical button, the application configures a prompt based at least on the inputs received in user experience 500 and displays output received from a foundation model service in output pane 505.

Continuing the exemplary operational scenario illustrated in FIGS. 5A-5F, in FIG. 5D, the application displays in output pane 505 a custom reading passage generated based on the prompt configured by the application based on the user or teacher input. The custom reading passage includes the three selected words of trouble words 504 highlighted in bold in the passage. In user experience 500, the teacher can modify parameters of configuration pane 503 or the selection of trouble words from among trouble words 504 and request a new custom reading passage. Upon clicking the “Use Passage” graphical button, the application displays user experience 500 of FIG. 5E.

Continuing user experience 500 in FIG. 5E, the teacher can configure a reading assignment based on the custom reading passage received from the foundation model service. In configuration pane 507, the teacher can input tags or selections for classifying the reading passage for later use, such as in other assignments. For example, the teacher can indicate a reading level of the passage and a genre as well as other assignment parameters. Also in configuration pane 507, the teacher can indicate the number of attempts which students are allowed to make in completing the assignment and a time limit or due date for completing the assignment. The teacher can also include the speech engine or other pronunciation service to capture audio data of a student reading the passage aloud and analyze the audio data to provide feedback on the student's performance. The teacher can fine-tune the speech engine with regard to its sensitivity to students' pronunciation. The teacher can also create an assignment which records video of one or more attempts by the student to complete the assignment.

In an alternative implementation of user experience 500, the teacher has requested a custom reading passage in Spanish. FIG. 5F illustrates the custom reading passage generated by the foundation model service accordingly.

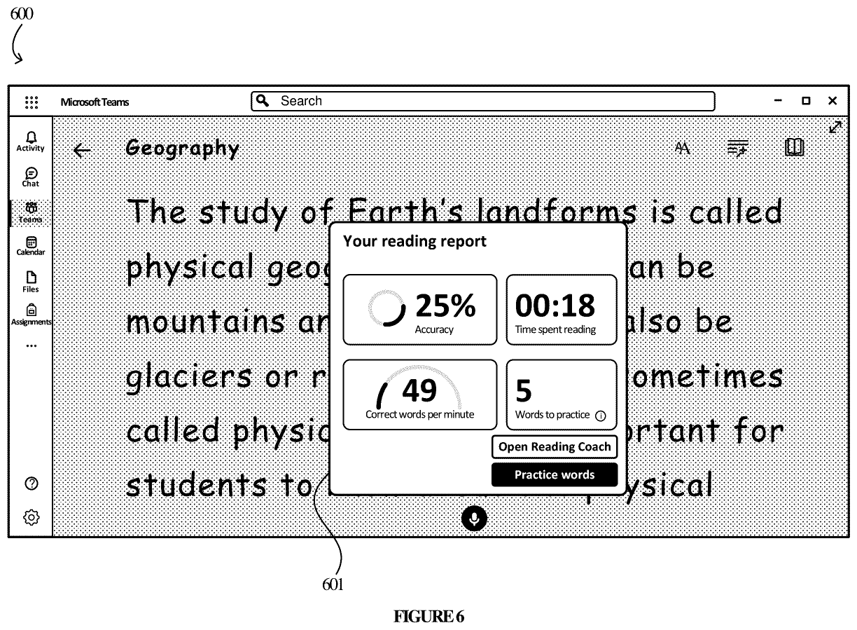

FIG. 6 illustrates user experience 600 of a reading instruction application hosted by an application service and executing on a student computing device in an implementation. In user experience 600, a custom reading passage is displayed in the user interface of the reading instruction application. When the student clicks a record button (not shown), a speech engine or other pronunciation service operating in association with the reading instruction application captures audio data of the student reading the custom reading passage. When the student completes the reading, the speech engine generates pop-up window 601 which presents an analysis of the student's reading ability based on the captured audio data.

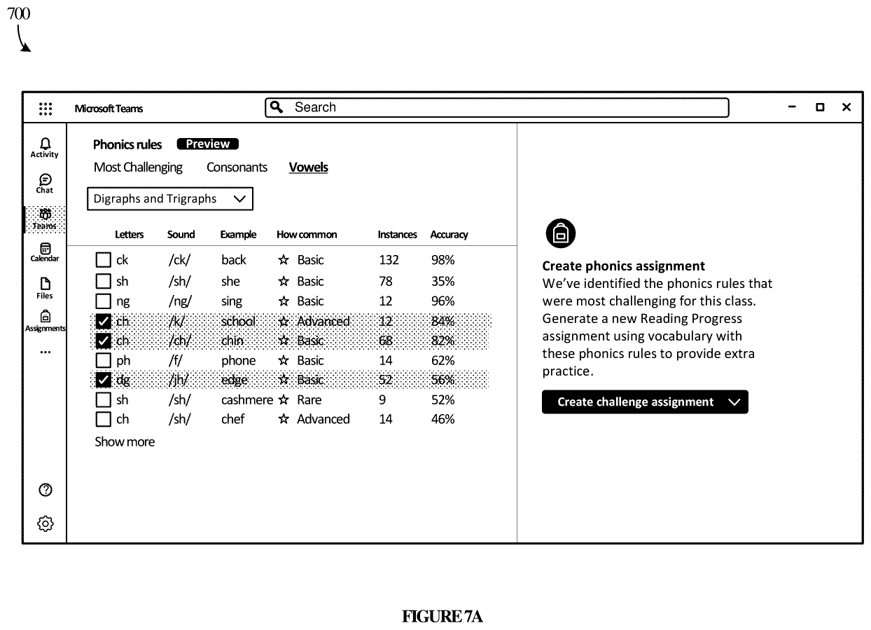

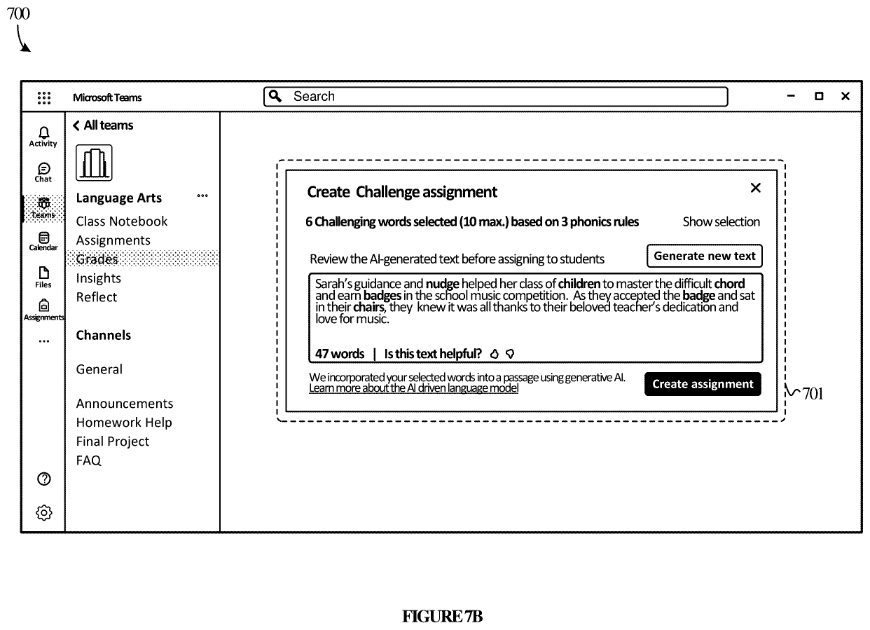

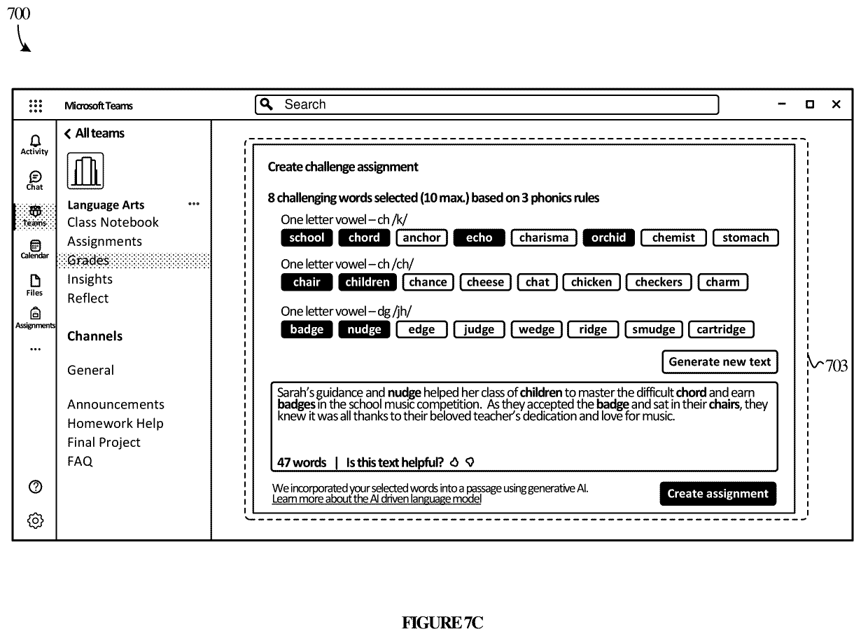

FIGS. 7A-7C illustrate user experience 700 in an implementation that is representative of the user experiences discussed above for an application service with an LLM integration. In user experience 700 of FIG. 7A, the teacher can select phonics rules or phonemes on which to base the custom reading passage. In an implementation, the reading instruction application tasks an LLM in the prompt with generating a custom reading passage which includes words incorporating the selected phonics rules or phonemes.

In FIG. 7B, the reading instruction application displays pop-up window 701 in user experience 700 where the teacher can review a custom reading passage generated by the LLM based on prompt including the selected phonics rules or phonemes.

Continuing with FIG. 7C, the reading instruction application displays pop-window 703 where the teacher can select particular words or trouble words to incorporate in the custom reading passage review based on the selected phonics rules or phonemes and review the custom reading passage generated by the LLM based on a prompt including the selected words.

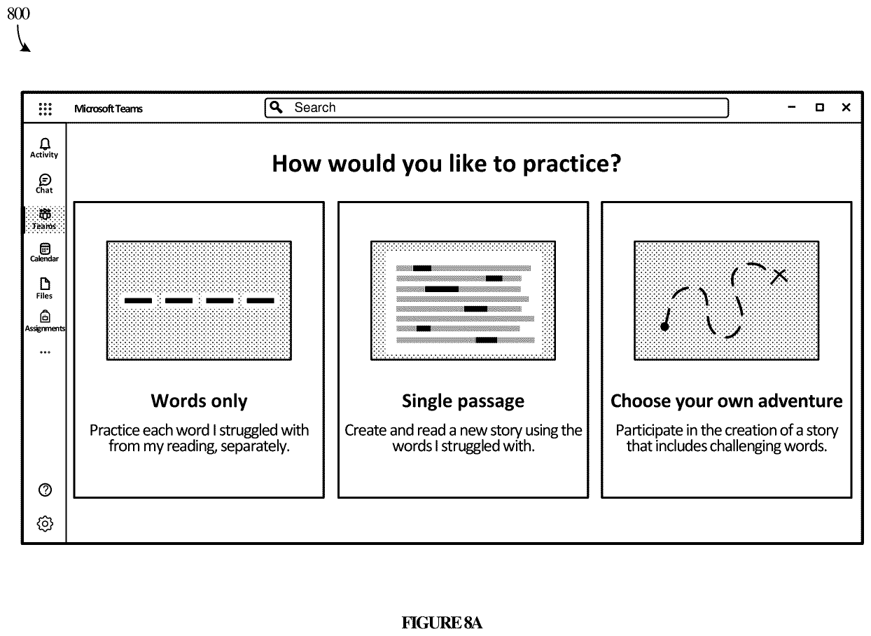

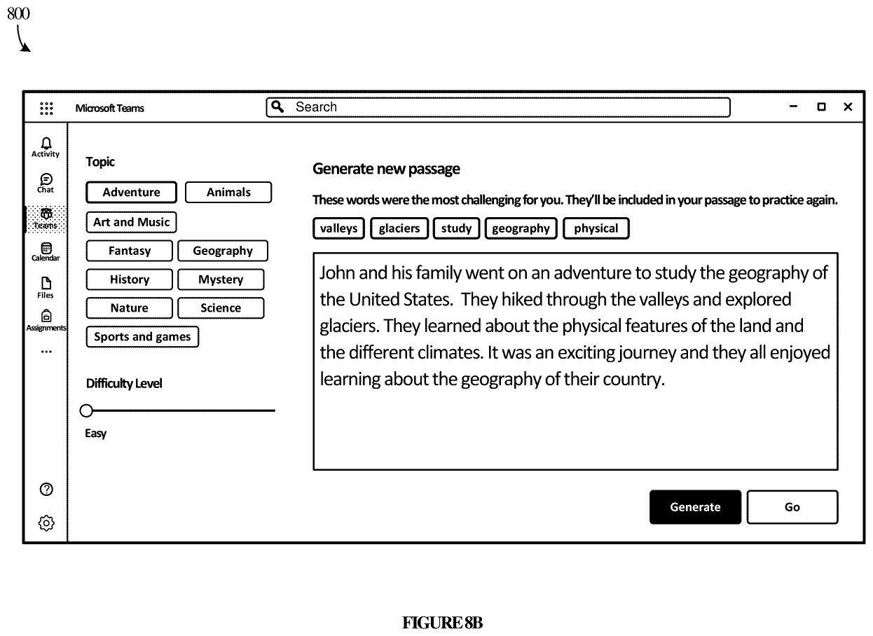

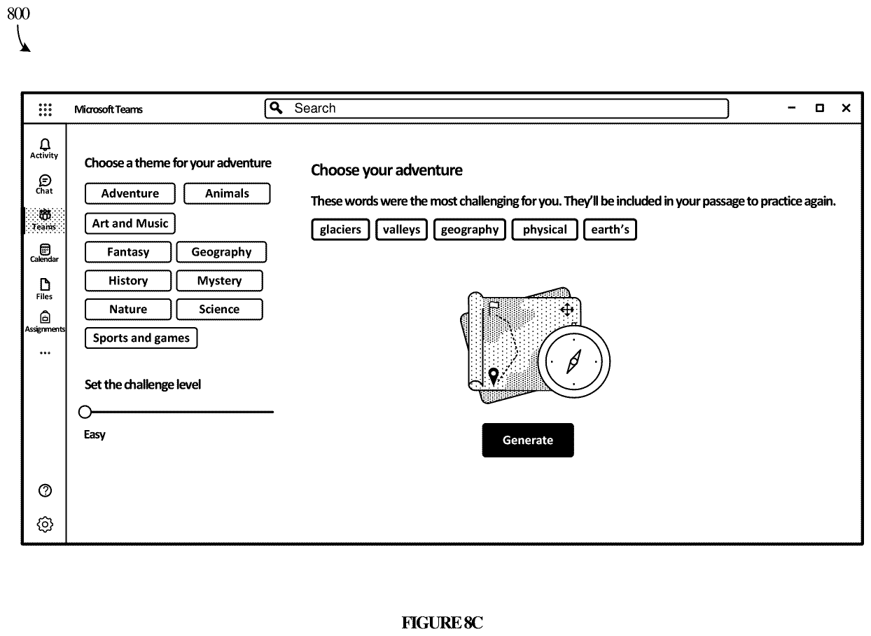

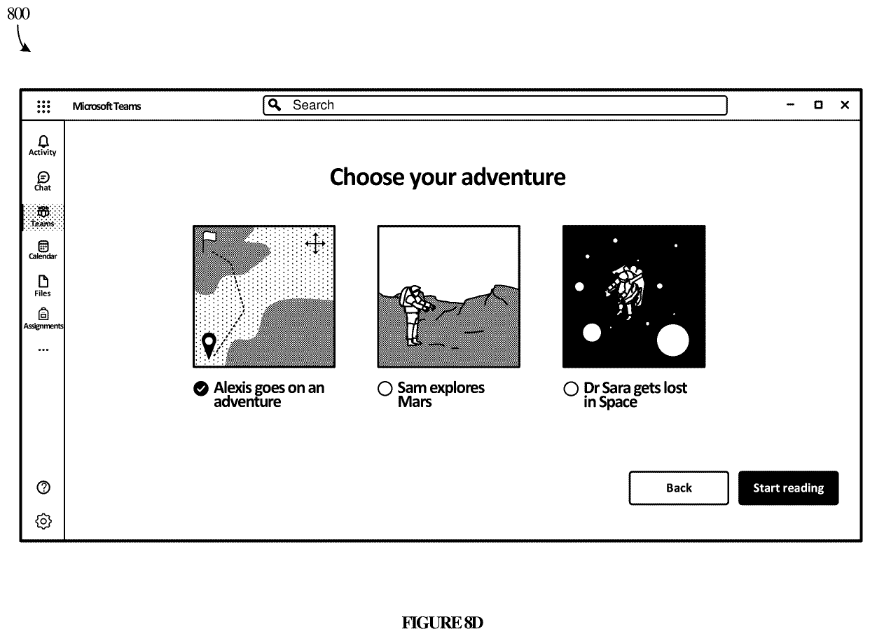

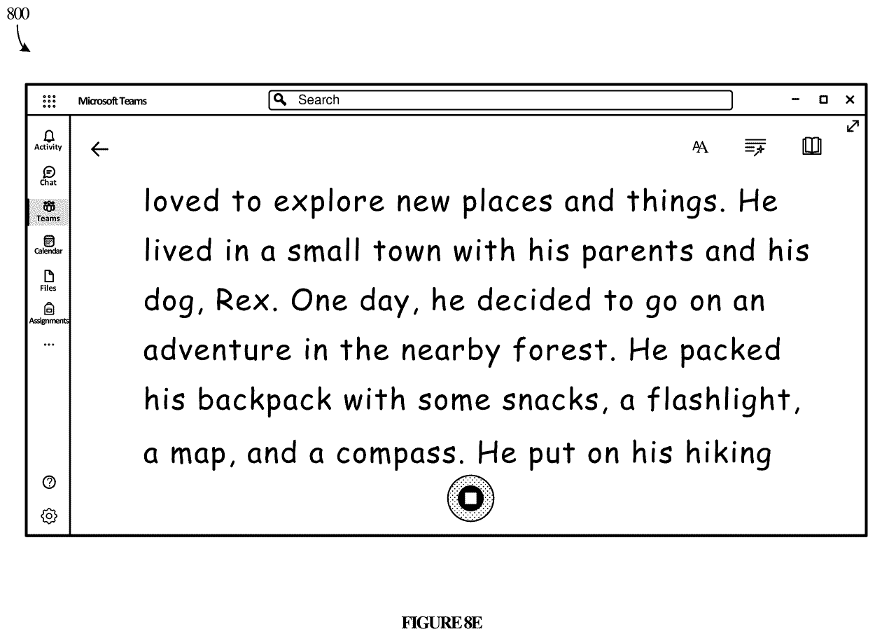

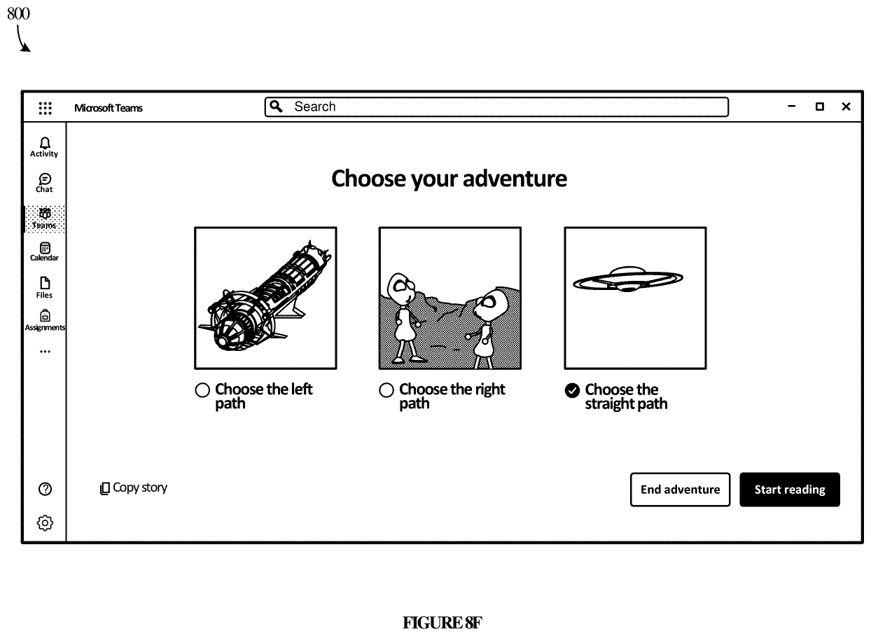

FIGS. 8A-8F illustrate user experience 800 in an operational scenario of the technology disclosed herein for an application service with a foundation model integration, such as an LLM or multimodal model integration. In FIG. 8A, a student user is presented with the option of practicing reading via student-initiated custom reading passages, “Single passage” and “Choose your own adventure.” For both scenarios, custom reading passages are generated incorporating trouble words identified for the student. In the figures that follow, user interfaces are illustrated which show the user interfaces displayed by the reading application for both scenarios.

FIG. 8B illustrates user experience 800 when the student user selects “Single passage.” User experience 800 presents trouble words identified by the reading application for that particular user. In an implementation, the student's trouble words were identified by a speech engine or insights engine based on audio data captured of the student reading one or more selected passages. In FIG. 8B, the student can select a topic and difficulty level for the passage. Upon clicking “Generate,” the reading application presents the custom reading passage configured according to a prompt generated by the reading application. The prompt generated by the reading application includes the trouble words presented in user experience 800 along with the student-selected parameters, but may include other tasks, instructions, or rules to ensure that the generated content is appropriate (e.g., contains no offensive content). For example, the foundation model service may be tasked with also incorporating words with phonemes or based on phonics rules with which the student has had difficulty as determined by the speech engine. In an implementation, the reading application evaluates the custom reading passage received from the foundation model service for appropriate content and difficulty prior to presenting the passage in the user interface.

Continuing to FIG. 8C, user experience 800 of FIG. 8C illustrates the user interface presented to the student when the student selects “Choose your own adventure” as shown in FIG. 8A. In FIG. 8C, the student is again presented with trouble words identified for the particular student along with options for creating a story of particular topic or genre. The student may also select a level of reading difficulty.

FIG. 8D illustrates custom artwork generated by an AI artwork generator based on custom reading passages or custom story prompts or plots generated by the foundation model service in response to the user input. In some implementations, the AI artwork generator is a generative model, such as a multimodal model, trained to generate imagery based on text input, and the custom artwork is generated by the model according to the reading passage generated by an LLM service. In the same or other scenarios, a multimodal model generates both the text output (i.e., the custom reading passage or story prompt) based on the prompt as well as the custom artwork for the text output. In user experience 800 of FIG. 8D, the student can select the story prompt or plot which will be used to generate a custom story incorporating the student's trouble words (or words containing trouble phonemes or phonics rules) for read-aloud practice.

FIG. 8E illustrates a portion of the custom reading passage generated based on the selection made by the user in FIG. 8D. As the custom reading passage is displayed in the application, the student initiates a recording of audio of the student reading the passage aloud. The audio data collected as the student reads is analyzed to provide feedback about the student's reading ability, to determine whether the student has gained proficiency in the trouble words, and to suggest new trouble words.

FIG. 8F illustrates user experience 800 when a student has completed reading a custom passage of the custom generated story and is presented with plot options for determining how the story continues. When the student selects a plot option, the application service generates a prompt by which to elicit from the foundation model service a continuation of the story based on the selected option. The prompt may include the story plots selected by the user and as well as the story continuations generated by the foundation model up to that point to provide a basis for the foundation model to generate a logical continuation of the story line. Here, too, custom artwork is generated according to the story prompts generated by the foundation model for continuing the story.

In user experience 800, the student can select an option to continue the story, or the student can end the story. In some implementations, the application service may allow the student's reading instructor to set a maximum number of continuations (or an unlimited number of continuations) that a student can implement to continue his or her story. The student may also be presented in the user interface with the option to copy or print the story to read again at a later time. For example, the reading application may present the option to create a PDF of the story generated for the student, including the custom-generated artwork, so the student can practice reading the story off-line. The reading application may also present an option to save the story, including the prompts used to generate the continuations, when the student exits the application so that the student can pick up and continue the story in a later session.

In various implementations, as the student reads the ongoing custom story, audio data of the student reading aloud is captured and analyzed, the results of which are made available to the student's reading instructor in an instructor version of the application.

Just as FIGS. 8A-8F illustrate a scenario for a foundation model integration for auto-generated reading passages that is beyond a student-teacher context, in various implementations, the technology disclosed herein is also suited to self-guided reading practice and instruction. For example, for individuals looking to improve their reading abilities, vocabulary, oral language skills, etc., the technology may be incorporated into applications for self-guided instruction and practice. In an implementation of a self-guided application, the user may be initially evaluated by a reading coach component or speech engine, and the application may prompt the foundation model service with generating reading passages according to an assessment of the reader's ability (e.g., identification of the reader's trouble words). The reader may be presented in an interface with a number of options for how the reading passages are to be configured, such as indicating a genre, a topic of interest or writing style (e.g., humorous, informal, educational), level of difficulty, and length. The application configures a prompt tasking the foundation model service with generating a reading passage according to the user input and trouble words identified by the reading coach. In some implementations, a self-guided application may be used for foreign language practice by tasking the foundation model service with generating reading passages in a language which the user wishes to learn.

As the reader reads the generated passages aloud, the reading coach component assesses and updates its prompts to the foundation model service according to the reader's progress, for example, by scaffolded learning or spaced repetition techniques. By customizing reading passages according to prompts which are based on the reader's interests and abilities, self-guided reading instruction is made much less pedantic and much more engaging.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements reading instruction process 906, which is representative of the reading instruction processes discussed with respect to the preceding Figures, such as process 200. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including reading instruction process 906) may be implemented in program instructions and among other functions may, when executed by processing system 902, direct processing system 902 to operate as described with respect to the various operational scenarios, sequences, and processes illustrated herein. For example, software 905 may include program instructions for implementing a reading instruction process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to custom reading passage generation for reading instruction in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all be generally referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of video conferencing solutions and productivity applications, they apply as well to other contexts such as gaming applications, virtual and augmented reality applications, business applications, and other types of software applications. Likewise, the concepts apply not just to video conferencing content and environments but to other types of content and environments such as productivity applications, gaming applications, and the like. Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
an application comprising program instructions stored on the one or more computer readable storage media that, when executed by the one or more processors, direct the computing apparatus to at least:
identify trouble words associated with a reader, wherein the trouble words comprise words classified as challenging with respect to a reading ability of the reader;
generate a prompt with which to elicit a response from a foundation model service that includes a reading passage tailored to the reading ability of the reader, wherein the prompt includes instructions for generating the reading passage using one or more of the trouble words; and
enable display of the reading passage in a user interface to the application.

2. The computing apparatus of claim 1, wherein to identify the trouble words associated with the reader, the program instructions further direct the computing apparatus to display, in the user interface of the application, a set of trouble words generated by a speech engine and receive, via the user interface, user input comprising a selection of the trouble words from the set of trouble words.

3. The computing apparatus of claim 2, wherein the program instructions further direct the computing apparatus to receive, via the user interface, parameters relating to the reading ability of the reader.

4. The computing apparatus of claim 3, wherein the prompt includes the parameters relating to the reading ability of the reader.

5. The computing apparatus of claim 4, wherein the parameters relating to the reading ability of the reader include topic, age range, length, level of difficulty, and language.

6. The computing apparatus of claim 5, wherein the program instructions further direct the computing apparatus to evaluate the reading passage according to one or more of the parameters and submit a second prompt to the foundation model service to generate a second reading passage which comprises a modification to the reading passage.

7. The computing apparatus of claim 1, wherein the application executes in a context of a collaboration application executing on the computer.

8. The computing apparatus of claim 1, wherein the program instructions further direct the computing apparatus to create a reading assignment including the reading passage based on assignment parameters.

9. The computing apparatus of claim 8, wherein the assignment parameters include one or more of: level of difficulty, genre, number of attempts, time limit, and use of a pronunciation service.

10. A method of operating an application on a computer, comprising:
identifying trouble words associated with a reader, wherein the trouble words comprise words classified as challenging with respect to a reading ability of the reader;
generating a prompt with which to elicit a response from a foundation model service that includes a reading passage tailored to the reading ability of the reader, wherein the prompt includes instructions for generating the reading passage using one or more of the trouble words; and
enabling display of the reading passage in a user interface to the application.

11. The method of claim 10, wherein identifying the trouble words associated with the reader comprises displaying, in the user interface, a set of trouble words generated by a speech engine and receiving, via the user interface, user input comprising a selection of the trouble words from the set of trouble words.

12. The method of claim 11, further comprising receiving, via the user interface, parameters relating to the reading ability of the reader.

13. The method of claim 12, wherein the prompt includes the parameters relating to the reading ability of the reader.

14. The method of claim 13, wherein the parameters relating to the reading ability of the reader include topic, age range, length, reading difficulty, and language.

15. The method of claim 14, further comprising evaluating the reading passage according to one or more of the parameters and submitting a second prompt to the foundation model service to generate a second reading passage which comprises a modification to the reading passage.

16. The method of claim 12, further comprising creating a reading assignment including the reading passage, based on assignment parameters, wherein the assignment parameters include one or more of: level of difficulty, genre, number of attempts, time limit, and use of a pronunciation service.

17. One or more computer readable storage media having an application comprising program instructions stored thereon that, when executed by one or more processors operatively coupled with the one or more computer readable storage media, direct a computing device to at least:
identify trouble words associated with a reader, wherein the trouble words comprise words classified as challenging with respect to a reading ability of the reader;
generate a prompt with which to elicit a response from a foundation model service that includes a reading passage tailored to the reading ability of the reader, wherein the prompt includes instructions for generating the reading passage using one or more of the trouble words; and
enable display of the reading passage in a user interface of the application.

18. The one or more computer readable storage media of claim 17, wherein to identify the trouble words associated with the reader, the program instructions further direct the computing device to display, in the user interface, a set of trouble words generated by a speech engine and receive, via the user interface, user input comprising a selection of the trouble words from the set of trouble words.

19. The one or more computer readable storage media of claim 18, wherein the program instructions further direct the computing device to receive, via the user interface, parameters relating to the reading ability of the reader, and wherein the prompt includes the parameters relating to the reading ability of the reader, wherein the parameters include one or more of: topic, age range, length, level of difficulty, and language.

20. The one or more computer readable storage media of claim 19, wherein the program instructions further direct the computing device to create a reading assignment including the reading passage based on assignment parameters, wherein the assignment parameters include one or more of: level of difficulty, genre, number of attempts, time limit, use of a pronunciation service, and pronunciation sensitivity.
